(19) United States
(12) Patent Application Publication
(10) Pub. No.: US 2012/0040550 A1
(43) Pub. Date: Feb. 16, 2012

(54) ELECTRICAL CONNECTOR ASSEMBLY WITH A LATCH MECHANISM EASILY OPERATED

(75) Inventor: JERRY WU, Irvine, CA (US)

(73) Assignee: HON HAI PRECISION INDUSTRY CO., LTD., New Taipei (TW)

(21) Appl. No.: 13/206,516

(22) Filed: Aug. 10, 2011

(30) Foreign Application Priority Data
Aug. 10, 2010 (CN) 201020287391.7

(51) Int. Cl. H01R 13/627

(52) U.S. Cl. 439/352

(57) ABSTRACT

An electrical connector assembly (100), comprises: a housing (1) having a receiving room (11) therein; two paralleled printed circuit boards (2) received into the receiving room and engaged with the housing; a latching member (6) disposed in a receiving cavity (14) of the housing; a pulling member (7) disposed on a top surface of the housing; and a retaining piece (9) interconnecting the latching member and the pulling member.

### FIELD OF THE INVENTION

The present invention generally relates to connectors suitable for transmitting data, more specifically to input/output (I/O) connectors with high-density configuration and high data transmitting rate. This application relates to a copending application with the same inventor, the same assignee, the same title and the same filing date.

### DESCRIPTION OF PRIOR ART

One aspect that has been relatively constant in recent communication development is a desire to increase performance. Similarly, there has been constant desire to make things more compact (e.g., to increase density). For I/O connectors using in data communication, these desires create somewhat of a problem. Using higher frequencies (which are helpful to increase data rates) requires good electrical separation between signal terminals in a connector (so as to minimize cross-talk, for example). Making the connector smaller (e.g., making the terminal arrangement more dense), however, brings the terminals closer together and tends to decrease the electrical separation, which may lead to signal degradation.

In addition to the desire at increasing performance, there is also a desire to improve manufacturing. For example, as signaling frequencies increase, the tolerance of the locations of terminals, as well as their physical characteristics, become more important. Therefore, improvements to a connector design that would facilitate manufacturing while still providing a dense, high-performance connector would be appreciated.

Additionally, there is a desire to increase the density of I/O plug-style connectors and this is difficult to do without increasing the width of the connectors. Increasing the width of the plug connectors leads to difficulty in fitting the plug into standard width routers and/or servers, and would require a user to purchase non-standard equipment to accommodate the wider plug converters. As with any connector, it is desirable to provide a reliable latching mechanism to latch the plug connector to an external housing to maintain the mated plug and receptacle connectors together modifying the size and/or configuration the connector housing may result in a poor support for a latching mechanism. Latching mechanisms need to be supported reliably on connector housings in order to effect multiple mating cycles. Accordingly, certain individuals would appreciate a higher density connector that does not have increased width dimensions and which has a reliable latching mechanism associated therewith.

As discussed above, an improved electrical connector overcoming the shortages of existing technology is needed.

### SUMMARY OF THE INVENTION

Accordingly, an object of the present invention is to provide an electrical connector assembly with a reliable latch mechanism.

In order to achieve the above-mentioned objects, an electrical connector assembly, comprises a housing having a receiving room therein; two paralleled printed circuit boards received into the receiving room and engaged with the housing; a latching member disposed in a receiving cavity of the housing; a pulling member disposed on a top surface of the housing; and a retaining piece interconnecting the latching member and the pulling member.

Other objects, features and advantages of the invention will be apparent from the following detailed description taken in connection with the accompanying drawings.

### BRIEF DESCRIPTION OF THE DRAWINGS

FIG. 1 is a perspective view of an electrical connector assembly in accordance with the present invention;

FIG. 2 is another perspective view of the electrical connector assembly of FIG. 1;

FIG. 3 is a partial exploded, perspective view of the electrical connector assembly of FIG. 1;

FIG. 4 is similar to FIG. 3, but viewed from another aspect;

FIG. 5 is another partial exploded, perspective view of the electrical connector assembly of FIG. 1;

FIG. 6 is similar to FIG. 5, but viewed from another aspect;

FIG. 7 is an exploded view of the electrical connector assembly of FIG. 1;

FIG. 8 is similar to FIG. 7, but viewed from another aspect;

FIG. 9 is a cross section view of the electrical connector assembly of FIG. 1 taken along line 9-9;

FIG. 10 is a cross section view of the electrical connector assembly of FIG. 1 taken along line 10-10;

FIG. 11 is a cross section view of the electrical connector assembly of FIG. 1 taken along line 11-11;

FIG. 12 is a cross section view of the electrical connector assembly of FIG. 1 taken along line 12-12;

### DETAILED DESCRIPTION OF PREFERRED EMBODIMENTS

Reference will now be made to the drawing figures to describe the present invention in detail.

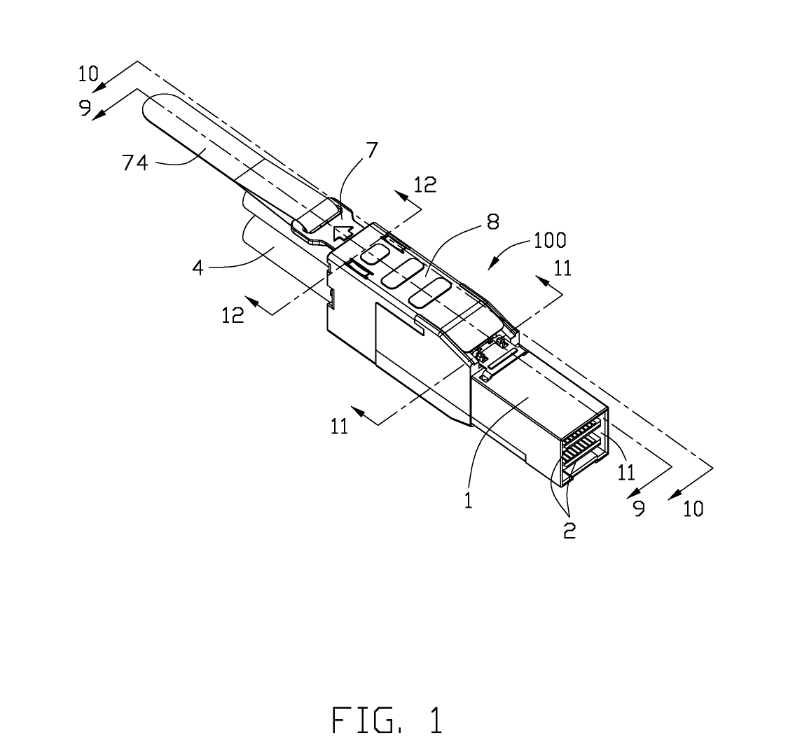

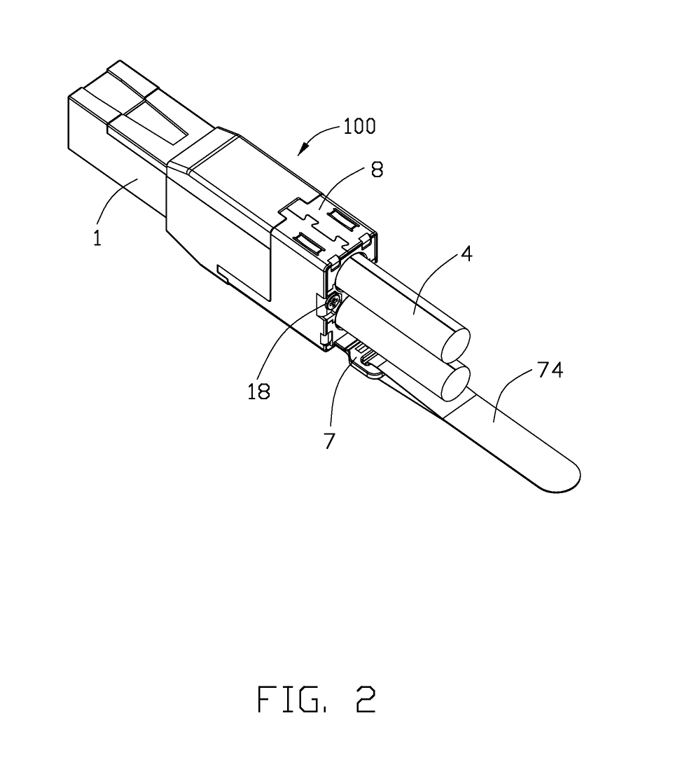

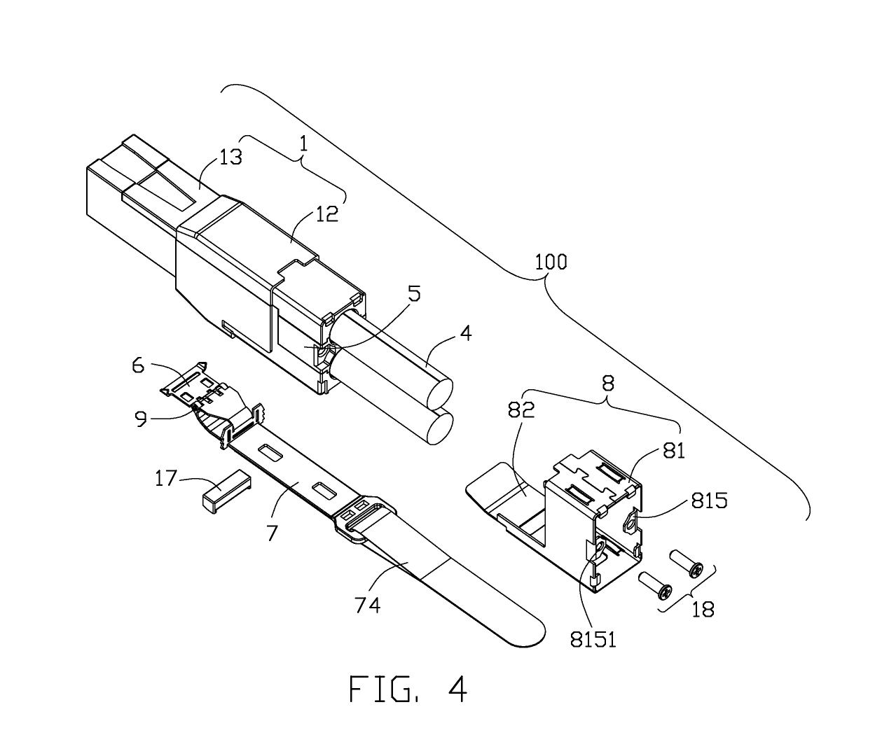

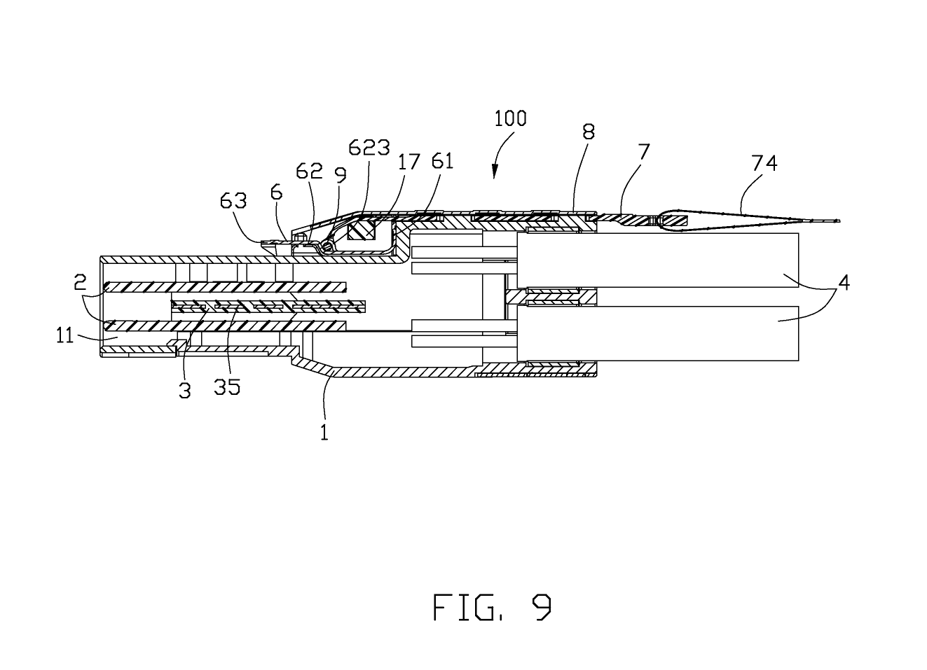

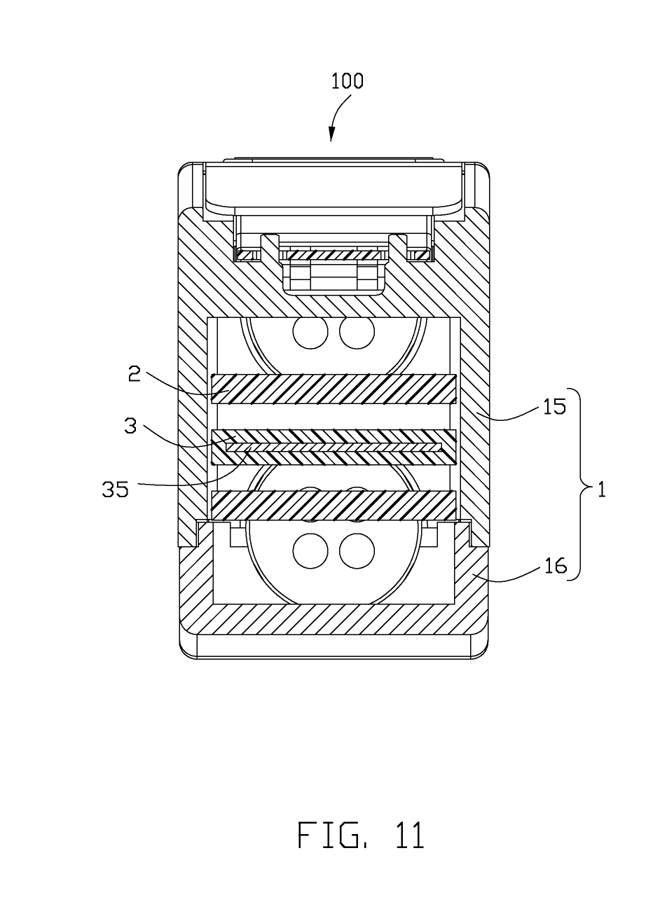

FIGS. 1 to 4 illustrate perspective views of an electrical connector assembly 100 made in accordance with the present invention. And in conjunction with FIGS. 9 to 12, the electrical connector assembly 100 comprises a housing 1 having a receiving room 11 therein, two paralleled printed circuit boards (PCBs) 2 disposed in the receiving room 11, a spacer 3 disposed between the two printed circuits boards 2 and positioned with the housing 1, two cables 4 respectively electrically connected with a printed circuit board 2 and a strain relief 5 disposed in the housing 1 and spaced apart with the two cables 4. The strain relief 5 has two side surfaces respectively in alignment with two side surfaces of the housing 1. The electrical connector assembly 100 further comprises a latch mechanism assembled to a top surface of the housing 1 and a metallic holder 8 surrounding a portion of the housing 1 and the latch mechanism. The latch mechanism comprises a latching member 6 and a pulling member 7 interconnected with each other.

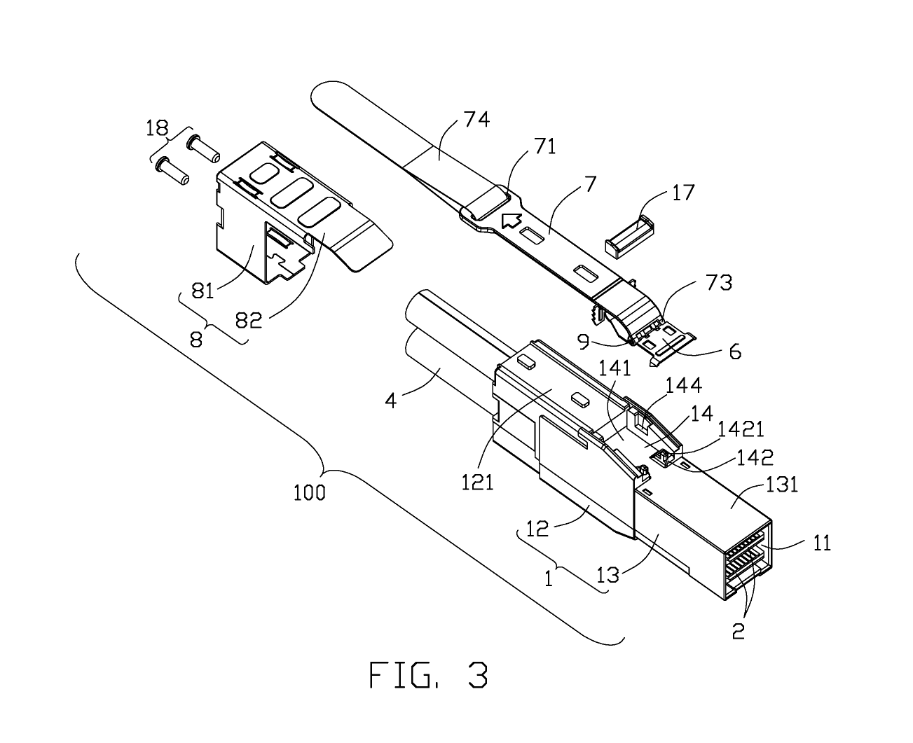

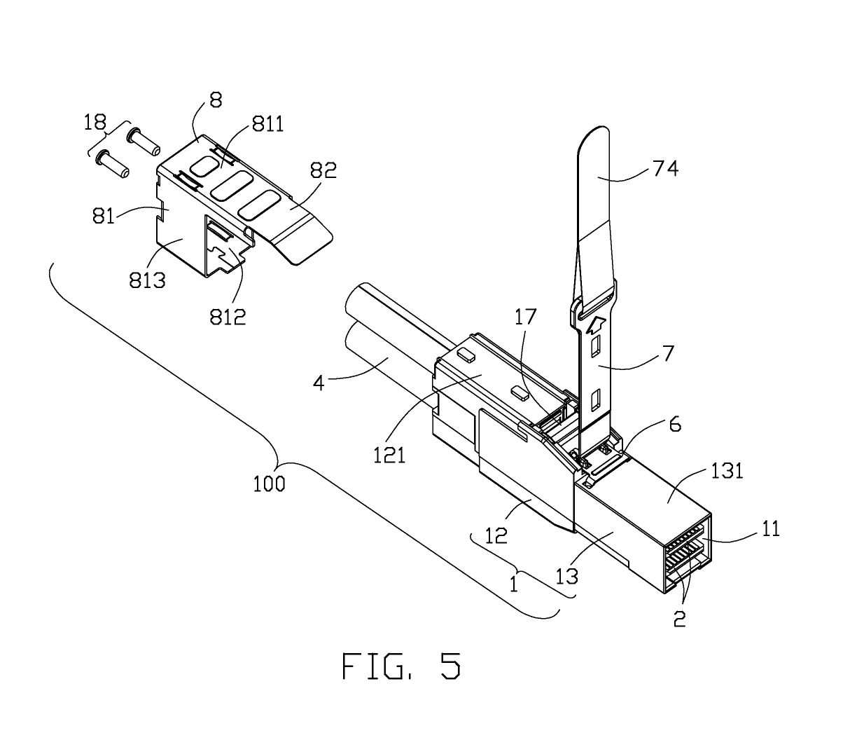

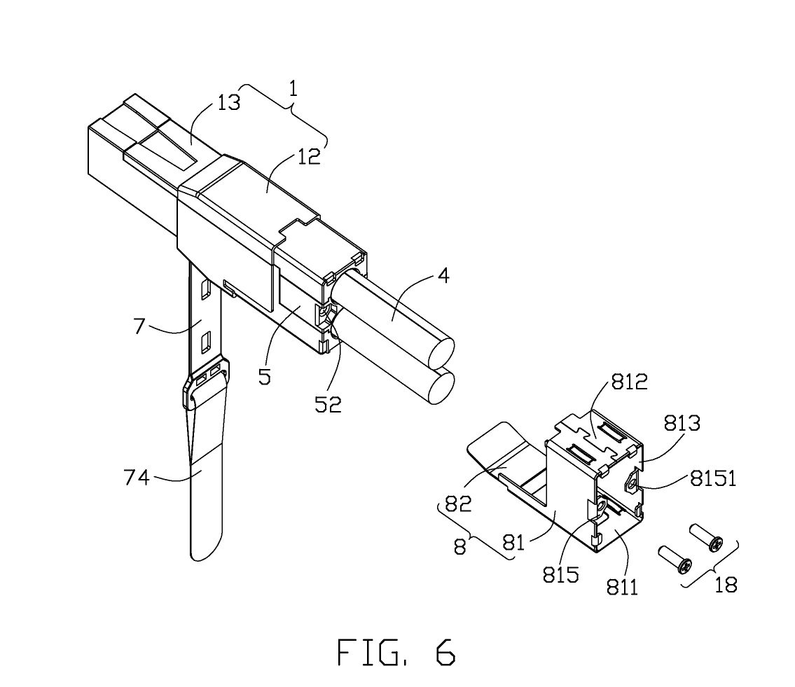

Referring to FIGS. 3 to 8, the housing 1 is made of metallic material and formed in a die-cast manner. The housing 1 defines a body portion 12 and a mating portion 13 extending forward from the body portion 12 for mating to a complementary connector (not shown). The body portion 12 has a cross section larger than that of mating portion 13. The housing 1 defines a receiving room 11 extending rearward from a front surface to a rear surface thereof. The body portion 12 of the housing 1 has a top surface defined as a first surface 121, the mating portion 13 of the housing 1 has a top surface defined as a second surface 131. The first surface 121 is disposed above the second surface 131. And, the first surface 121 defines an inclined surface extending toward to the second surface 131. The body portion 12 defines a receiving cavity 14 extending downwardly from the inclined surface for a distance. The receiving cavity 14 has a bottom surface 141 located on a same level with the second face 131. And, the bottom surface 141 is defined as a third surface. A pair of prominences 142 are formed in a front edge of the receiving cavity 14 and spaced apart with each other along a transversal direction. A cutout (not figured) is formed between the two prominences 142. Thus, the second surface 131 is communicated with the third surface 131 along a front to rear direction. And, each of the prominence 142 further defines a protrusions 1421 formed on a top surface thereof. In addition, the receiving cavity 14 defines two recesses 144 formed on two inner side surfaces thereof. A supporting piece 17 has two side portions respectively received into the two recesses 144. Thus, the supporting piece 17 is positioned with the housing 1 for supporting the pulling member 7.

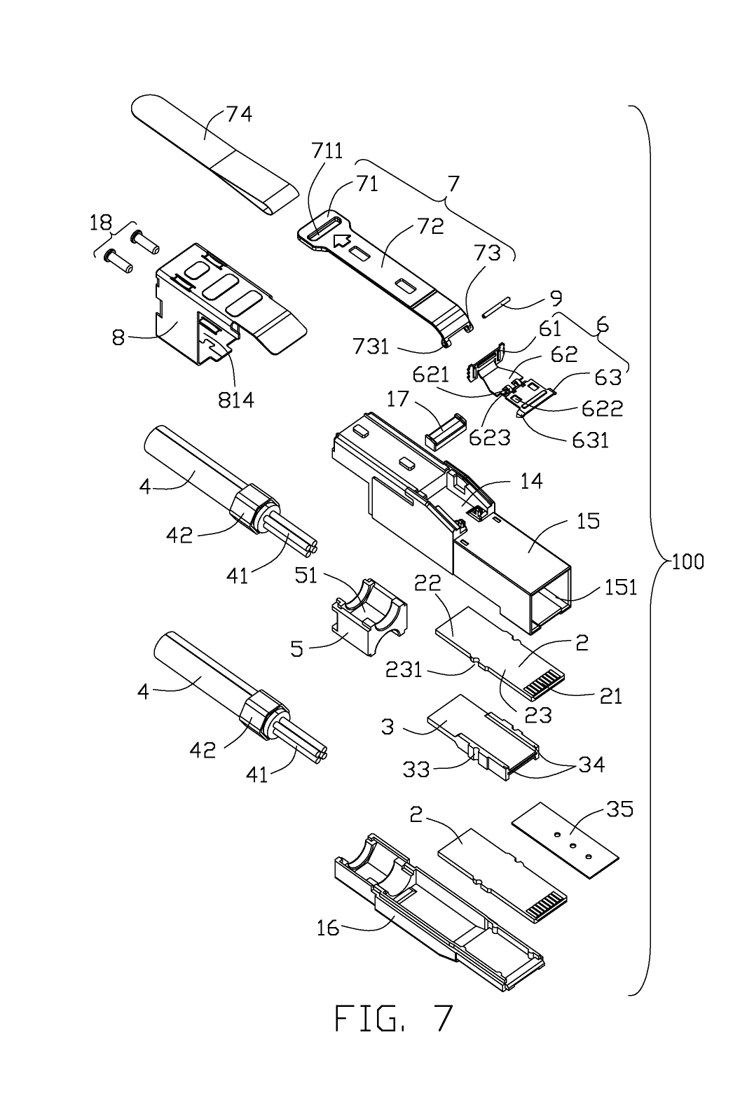

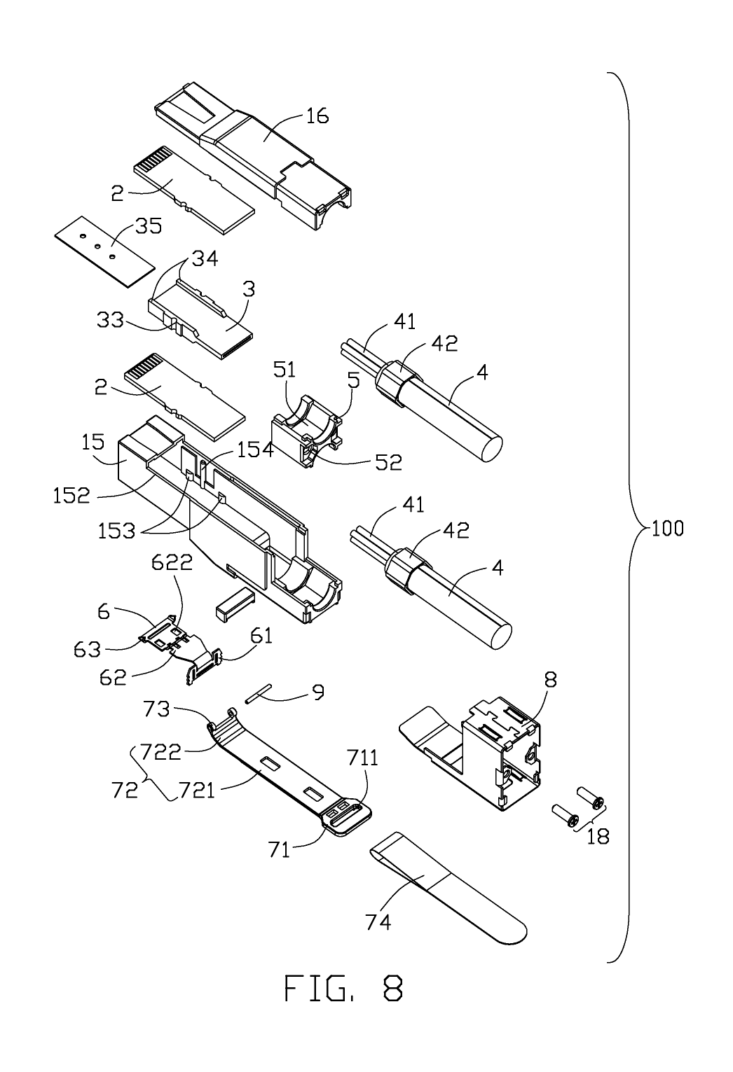

Referring to FIGS. 7 to 8, the housing 1 comprises a box-shape first shield part 15 and a second shield part 16 assembled with each other. The first shield part 15 defines a rectangular frame 151 formed at a front end thereof and defined as a mating port of the housing 1. The first shield part 15 further defines an opening 152 formed at a bottom end thereof. The opening 152 of the first shield part 15 will be shielded when the second shield part 16 is assembled to the first shield part 15. The first shield part 15 defines two first positioning posts 153 formed on an inner side surface thereof and another two first positioning posts 153 formed on another inner side surface thereof. Each of the two first positioning posts 153 are spaced apart with each other along a front-to-rear direction. Each of the first positioning post 153 has a semi-circular cross section. The first positioning posts 153 are used for supporting the printed circuit board 2 along an up-to-down direction. In addition, two second positioning posts 154 are respectively formed on two inner side surface of the first shield part 15. Each of second positioning post 154 is disposed between the two first positioning posts 154 along a front-to-rear direction and used for limiting a movement of the printed circuit board 2 along a front to rear direction. Each of second positioning post 154 also has a semi-circular cross section. And, the second positioning post 154 is longer than the first positioning post 153 along an up-to-down direction.

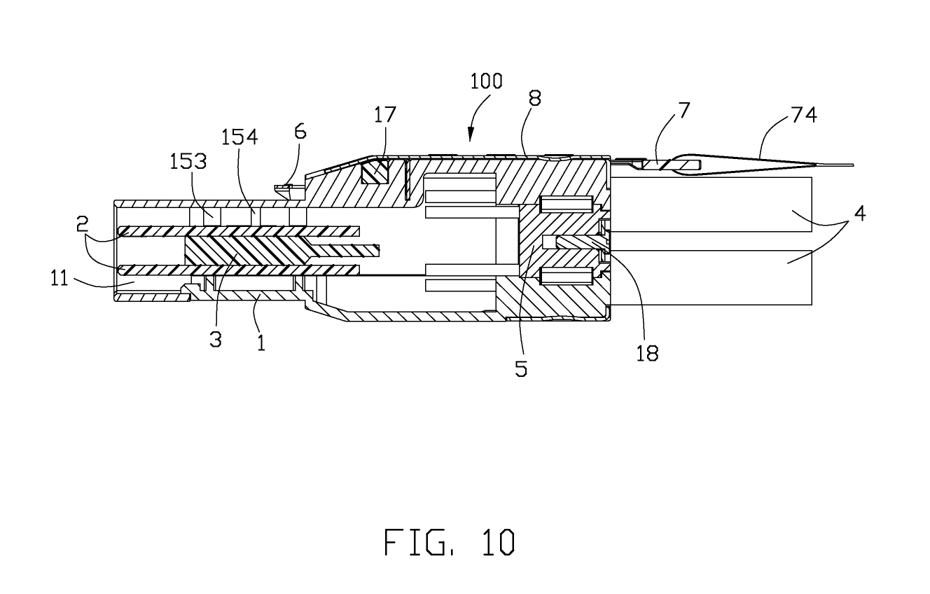

Referring to FIGS. 7 and in conjunction with FIGS. 9 to 10, two printed circuit boards 2 are received into the receiving room 11 of the insulative housing 1. Each of the printed circuit board 2 has a mating section 21 formed at a front end thereof, a terminating section 22 formed at a rear end thereof and a connecting section 23 disposed between the mating section 21 and the terminating section 22. A pair of slots 231 are respectively formed at two sides of the connecting section 23 of the printed circuit board 2. The pair of slots 231 are cooperated with two second positioning posts 154 along a vertical direction for limiting a movement along a front to rear direction.

Referring to FIGS. 7 to 9, a spacer 3 is formed of insulative material and defines an upper surface and a lower surface. The spacer 3 defines a pair of ribs 34 formed at two sides of the upper surface thereof and another pair of ribs 34 formed at two sides of the lower surface thereof for supporting the two printed circuit boards 2. The spacer 3 further defines a pair of grooves 33 respectively formed on two sides thereof and extending along a vertical direction for cooperating with the corresponding second positioning posts 154. The spacer 3 further defines a grounding plate 35 integrative formed therein.

Referring to FIGS. 7 to 8, two cables 4 are respectively electrically connected with two printed circuit boards 2. Each of the cable 4 has a plurality of conductors 41 formed therein and a ring 42 formed at a front end thereof.

Referring to FIGS. 7 to 8 and in conjunction with FIG. 10, a strain relief 5 is made of metallic material and received into a receiving room 11 of the housing 1. The strain relief 5 has two depressed sections 51 respectively formed on a top and bottom surfaces thereof for receiving a portion of the two rings 42. The strain relief 5 defines a pair of receiving holes 52 formed on a rear surface thereof. The electrical connector assembly 100 further comprises a pair of engaging devices 18 received into the pair of receiving holes 52. In this embodiment, the engaging device 18 is a screw. The metallic holder 8 is interconnected with the strain relief 5 through the pair of screws 18.

Referring to FIGS. 3 to 9, the latching member 6 is stamped and formed from a metallic plate and comprises a vertical retaining portion 61, a connecting portion 62 extending forwardly from a bottom side of the retaining portion 61 and a latching portion 63 extending forwardly from the connecting portion 62. A front portion of the latch 6 is defined as a latching portion 63. The retaining portion 61 defines a plurality of sharp projections (not figured) formed at two sides thereof. The connecting portion 62 defines a pair of quadrate holes 622 cooperated with the pair of protrusions 1421 of the prominences 142. The latching portion 63 defines a pair of barbs 631 formed at two sides thereof. In addition, the connecting portion 62 further defines two hooks 623 formed on a top surface thereof. Thus, two through holes 621 are respectively formed by the two hooks 623 and the top surface of the connecting portion 62.

Referring to FIGS. 3 to 8, the pulling member 7 is made of insulative material and structured in a flat shape. The pulling member 7 defines two actuating sections 73 formed at a front end thereof, an operating section 71 formed at a rear end thereof and a connecting section 72 disposed between the two actuating sections 73 and the operating section 71. The connecting section 72 has a horizontal section 721 and a curving section 722. The actuating sections 73 and the curving section 722 are extended into the receiving cavity 14. The curving section 722 is supported by the supporting piece 17. Each of the actuating section 73 has a through hole 731 extending along a transversal direction. The operating section 73 defines a slit 711. A tape 74 is connected to the pulling member 7 through the slit 711.

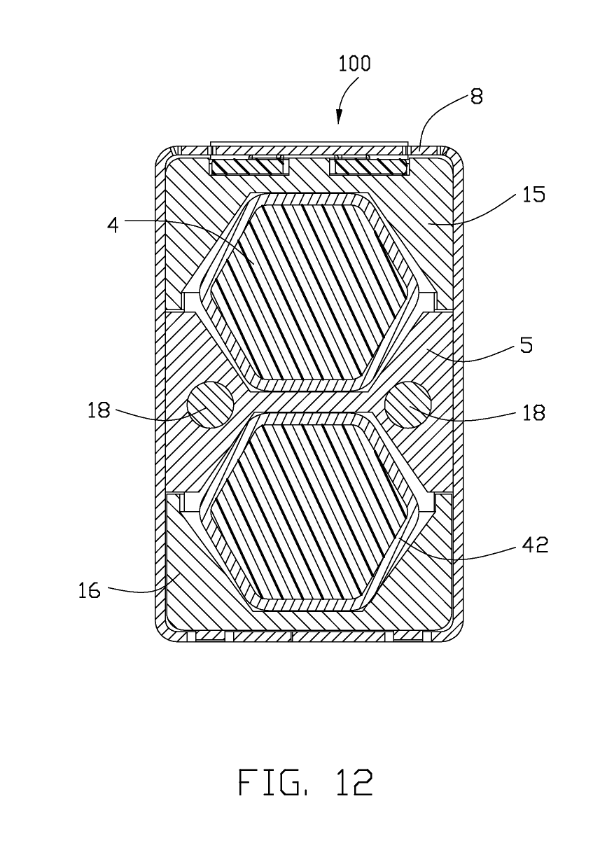

Referring to FIGS. 3 to 7 and in conjunction with FIGS. 9 and 12, the metallic holder 8 defines a base portion 81 and a shielding portion 82 extending forwardly from the base portion 81. The base portion 81 has a top wall 811, a bottom wall 812 and a pair of side walls 813 connected with the top wall 811 and the bottom wall 812. The base portion 81 defines a receiving space 814 surround by the top wall 811, the bottom wall 812 and the pair of side walls 813. The shielding portion 82 extends forwardly from the top wall 811. The top surface 121 of the body portion 12 of the housing 1 is shielded by the top wall 811 and the shielding portion 82. Each of the side wall 813 defines a tab 815 extending into the receiving space 814. Each of the tab 815 defines a through hole 8151 in alignment with the receiving hole 52 of the strain relief 5 along a front to rear direction. Each of the screw 18 is passed through the through hole 8151 of the tab 815 and received into the receiving hole 52 of the strain relief 5. Thus, the metallic holder 8 is interconnected with the strain relief 5 through the pair of screws 18. The metallic holder 8 is also interconnected with the housing 1 due to the strain relief 5 received in the housing 1.

Referring to FIGS. 3 to 9, the retaining piece 9 is a pin. The pulling member 7 is interconnected with the latching member 6 through the retaining piece 9.

Referring to FIGS. 1 to 12, the assembling process of the electrical connector assembly 100 made in according to the present invention starts from soldering the conductors 41 of each cable 41 to a terminating section 22 of the printed circuit board 2.

After the two cables 4 are respectively connected to the two printed circuit boards 2, then turning over the first shield part 15 to make the opening 152 facing upward and assembling the printed circuit board 2 to the first shield part 15 through the opening 152. The printed circuit board 2 is supported by the first positioning posts 153 of the shield part 15 along a vertical direction. The printed circuit board 2 is positioned with the first shield part 15 along a front-to-rear direction due to the pair of slots 231 of the printed circuit board 2 cooperated with the pair of second positioning posts 154 of the shield part 15. And, a front end of the cable 4 is supported by a rear end of the first shield part 15.

After the cable 4 and the printed circuit board 2 are assembled to the first shield part 15, then assembling the strain relief 5 to a rear end of first shield part 15. And, the ring 41 of the cable 4 is received into a space formed between the first shield part 15 and the strain relief 5.

After the strain relief 5 is assembled to the first shield part 15, then assembling the spacer 3 to the first shield part 15. The spacer 3 is positioned with the first shield part 15 and located on the printed circuit board 2. The pair of second positioning posts 154 of the first shield part 15 pass through the corresponding two grooves 33 of the spacer 3 along an up-to-down direction to limit a movement of the spacer 3 along a front to rear direction.

After the spacer 3 is assembled to the first shield part 15, then assembling another printed circuit board 2 and cable 4 together to the first shield part 15 and located on the spacer 3. The printed circuit board 2 is positioned with the first shield part 15 along a front-to-rear direction due to a pair of slots 231 of the printed circuit board 2 cooperated with the pair of second positioning posts 154 of the shield part 15. And, a front end of the cable 4 is supported by the strain relief 5. The ring 42 of the cable 4 has a half portion located in a depressed section 51 of the strain relief 5.

After another printed circuit board 2 and cable 4 are together assembled to the first shield part 15, then assembling the second shield part 16 to the first shield part 15. Thus, the opening 152 of the first shield part 15 is shielded by second shield part 16 along an up-to-down direction. And, the two printed circuit boards 2 and a spacer 3 are received into the receiving room 11 of the housing 1 and positioned in the housing 1.

After the second shield part 16 is assembled to the first shield part 15, then assembling the latching member 6 to the pulling member 7 together through following steps. Firstly, the pulling member 7 is disposed above the latching member 6 to make the two through holes 731 of the two actuating sections 73 in alignment with two through holes 621 of the latching member 6 along a transversal direction. The pair of actuating sections 73 of the pulling member 7 are located at two sides of the two hooks 623 of the latching member 6. Secondly, the retaining piece 9 is passed through the through holes 621, 623. Thus, the pulling member 7 is interconnected with the latching member 6 by the retaining piece 9. The pulling member 7 can be rotated to the latching member 6 based on the retaining piece 9 along a clockwise direction.

Then, assembling the latching member 6 and the pulling member 7 together to an exterior surface of housing 1. The latching member 6 is disposed in the receiving cavity 14. The pulling member 7 is located on the top surface 121 of the body portion 12 of the housing 1. The supporting piece 17 is disposed in the receiving cavity 14 when the pulling member 7 is rotated along a clockwise direction. Two sides of the supporting piece 17 are received into the two recesses 144. The supporting piece 17 is spaced apart with the bottom surface 141 of the receiving cavity 14. Then, the pulling member 7 is rotated along a counter-clockwise direction and attached to the top surface 121 of the body portion 12 of the housing 1. Thus, the curving section 722 of the pulling member 7 is supported by the supporting piece 17. The retaining section 61 of the latching member 6 is engaged with a rear end of the receiving cavity 14. The connecting section 62 of the latching member 6 is disposed above the bottom surface 141 of the receiving cavity 14. The latching portion 63 extends forwardly and is located above the second surface 131 of the mating portion 13 of the housing 1. The latching portion 63 is cantilevered from the retaining portion 61. The two actuating sections 73 of the pulling member 7 is generally located above the connecting section 62 of the latching member 6. A tape 74 is passed through the slit 711 and connected to the pulling member 7. When a rearward pulling force is exerted on a rear end of the pulling member 7 or the tape 74, the latching portion 63 of the latching member 6 will be raised up. When the rearward pulling force is released, the latching portion 63 of the latching member 6 will resume to an original state.

Finally, assembling the metallic holder 8 to the housing 1 along a rear-to-front direction. The first part 15, the second shield part 16 and the strain relief 5 are bound together by the metallic holder 8. A portion of the pulling member 7 and the latching member 6 is also shielded by the metallic holder 8. And, the pulling member 7 can be moved along a front to rear direction relative to the housing 1 and limited by the metallic holder 8 along a vertical direction. Two tabs 815 are attached to the rear surface of the strain relief 5. Two retaining pieces 9 are respectively passed through the two holes 8151 of the two tabs 815 and received into the two receiving holes 52 of the strain relief 5. Thus, the metallic holder 8 is engaged with the strain relief 5.

After the above assembling steps, the entire process of assembling of the electrical connector assembly 100 is finished. The electrical connector assembly 100 has a new mating surface to meet higher and higher data transmitting rate. In addition, the electrical connector assembly 1 has a narrow profile and high-density configuration. Thus, the complementary connector (not shown) for mating with the electrical connector assembly 100 will also occupy little space to meet a miniaturization of an internal room of the communication device. On another aspect, a reliable latch mechanism is provided to an exterior surface of the housing. And, an easily and conveniently operating manner between the latching member 6 and the pulling member 7 is achieved.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. An electrical connector assembly, comprising:
a housing having a receiving room therein;
two paralleled printed circuit boards received into the receiving room and engaged with the housing;
a latching member disposed in a receiving cavity of the housing;
a pulling member disposed on a top surface of the housing; and
a retaining piece interconnecting the latching member and the pulling member.

2. The electrical connector assembly as recited in claim 1, wherein the electrical connector assembly further comprises two cables extending into the receiving room and respectively electrically connected with two printed circuit boards.

3. The electrical connector assembly as recited in claim 1, wherein the pulling member defines two front actuating sections, each of the actuating section defines a through hole extending along a transversal direction, the latching member defines at least one positioning hole in alignment with the through holes, the retaining piece is passed through the two through holes and the positioning hole to achieve an interconnection between the latching member and the pulling member.

4. The electrical connector assembly as recited in claim 1, wherein the electrical connector assembly further comprises a supporting piece disposed in the receiving cavity of the housing and disposed between the pulling member and the latching member along a vertical direction, and the pulling member has a portion supported by the supporting piece.

5. The electrical connector assembly as recited in claim 1, wherein the pulling member is disposed above the latching member.

6. The electrical connector assembly as recited in claim 1, wherein the receiving cavity is communicated with an exterior along a front to rear direction, the housing defining a body portion and a mating portion extending forwardly from the body portion, the receiving cavity has a bottom surface located on a same level to a top surface of the mating portion.

7. The electrical connector assembly as recited in claim 1, wherein the electrical connector assembly further comprises a strain relief disposed in the housing and a metallic holder surrounding the housing and the strain relief.

8. The electrical connector assembly as recited in claim 7, wherein the electrical connector assembly further comprises a pair of retaining pieces interconnected the metallic holder to the strain relief.

9. The electrical connector assembly as recited in claim 8, wherein the housing comprises a first shield part and a second shield part assembled with each other.

10. The electrical connector assembly as recited in claim 1, wherein the electrical connector assembly further a spacer disposed between the two printed circuit boards, and the spacer defines a grounding plate integrative formed therein.

11. An electrical connector assembly, comprising:
a metallic housing having a mating port formed on a front end thereof;
a plurality of contacts formed in the mating port; and
a latch mechanism assembled to an exterior surface of the housing, the latch mechanism comprising a pulling member and a latching member interconnected with each other, the pulling member disposed above the latching member.

12. The electrical connector assembly as recited in claim 11, wherein the electrical connector assembly further defines a retaining piece passing through the pulling member and the latching member along a transversal to achieve an interconnection between the latching member and the pulling member.

13. The electrical connector assembly as recited in claim 11, wherein the electrical connector assembly further comprises a strain relief disposed in the housing and a metallic holder surrounding the housing and the strain relief.

14. The electrical connector assembly as recited in claim 11, wherein the electrical connector assembly further comprises a pair of retaining pieces interconnected the metallic holder to the strain relief.

15. The electrical connector assembly as recited in claim 14, wherein the housing comprises an upper shield part and a lower shield part assembled with each other.

16. An electrical connector assembly comprising:
a housing defining a mating port;
a deflectable latching member having a rear section fastening to an exterior face of the housing and a front section up and down moveable with regard to the exterior; and
a pulling member pivotally mounted to the front section of the latching member; wherein
a supporting piece is located above the latching member and below the pulling member to support the pulling member.

17. The electrical connector assembly as claimed in claim 16, wherein the supporting piece is discrete from the housing and assembled to the housing only after the latching member is assembled to the housing.

18. The electrical connector assembly as claimed in claim 16, wherein at least one protrusion is formed on the exterior face and an opening is formed in the pulling member to receive said protrusion for guiding back and forth movement of the pulling member with regard to the housing.

19. The electrical connector assembly as claimed in claim 18, further including a metallic holder to enclose the pulling member so as to assure the protrusion is received in the opening.

20. The electrical connector assembly as claimed in claim 16, wherein the latching member is split to form a through hole therein to receive a pin which assembles the pulling member and the latching member in a pivotal manner.
